(19) United States
(12) Patent Application Publication
(10) Pub. No.: US 2023/0091937 A1
(43) Pub. Date: Mar. 23, 2023

(54) CONNECTOR

(71) Applicant: SUMITOMO WIRING SYSTEMS, LTD., Mie (JP)

(72) Inventor: Yusuke WATANABE, Mie (JP)

(21) Appl. No.: 17/908,448

(22) PCT Filed: Mar. 2, 2021
(86) PCT No.: PCT/JP2021/007861

§ 371 Date: Aug. 31, 2022

(30) Foreign Application Priority Data
Mar. 4, 2020 (JP) 2020-037050

(51) Int. Cl. H01R 13/453; H01R 13/52; H01R 13/502

(52) U.S. Cl. CPC H01R 13/453; H01R 13/5202; H01R 13/502

(57) ABSTRACT

A connector according to one aspect of the present disclosure is provided with a housing having a facing surface facing a mating connector when the connector is assembled with the mating connector, a terminal held in the housing and projecting in a first direction from the facing surface, and a cover to be held on the housing. The housing includes a peripheral wall projecting in the first direction from the facing surface and provided to surround the terminal when viewed from a second direction opposite to the first direction and a connection opening formed by the peripheral wall surrounding the terminal when viewed from the second direction. The peripheral wall is provided with an exposure opening communicating with the connection opening and configured to expose inside of the housing.

### TECHNICAL FIELD

The present disclosure relates to a connector.

### BACKGROUND

Patent Document 1 describes a connector provided with a housing and a terminal. The housing holds the terminal. The housing includes a peripheral wall provided to surround the terminal. The housing is provided with a connection opening by the peripheral wall surrounding the terminal. Further, the peripheral wall is provided with an exposure opening communicating with the connection opening and configured to expose the inside of the housing. The connector described in patent literature 1 is assembled with a mating connector through the connection opening and the exposure opening.

### PRIOR ART DOCUMENT

### Patent Document

Patent Document 1: JP 2016-522550 A

### SUMMARY OF THE INVENTION

### Problems to be Solved

In the connector described in Patent Document 1, the inside of the housing is accessible through the connection opening and the exposure opening. Thus, worker's fingers may touch the terminal through the connection opening and the exposure opening.

The present disclosure aims to provide a connector capable of reducing a possibility that worker's fingers touch a terminal.

### Means to Solve the Problem

The present disclosure is directed to a connector with a housing having a facing surface facing a mating connector when the connector is assembled with the mating connector, a terminal held in the housing, the terminal projecting in a first direction from the facing surface, and a cover to be held on the housing, wherein the housing includes a peripheral wall projecting in the first direction from the facing surface and provided to surround the terminal when viewed from a second direction opposite to the first direction and a connection opening formed by the peripheral wall surrounding the terminal when viewed from the second direction, the peripheral wall is provided with an exposure opening communicating with the connection opening and configured to expose inside of the housing, and the cover is provided to be displaced between a first position where the cover closes the connection opening and the exposure opening and a second position where the cover is retracted from the connection opening and the exposure opening.

### Effect of the Invention

According to the connector of the present disclosure, an effect of being capable of suppressing a possibility that worker's fingers touch a terminal is achieved.

### BRIEF DESCRIPTION OF THE DRAWINGS

FIG. 1 is a perspective view showing one embodiment of an electrical connection device provided with a connector.

FIG. 2 is a plan view of a first connector viewed from a first direction.

FIG. 3 is a plan view of a second connector viewed from a second direction.

FIG. 4 is a plan view of FIG. 3 with a cover omitted.

FIG. 5 is a side view of the second connector.

FIG. 6 is a section along 6-6 in FIG. 3.

FIG. 7 is a front view of the second connector.

FIG. 8 is a section along 8-8 in FIG. 3.

FIG. 9 is a side view in which the cover is displaced to a second position from a position of FIG. 5.

FIG. 10 is a plan view in which the cover is displaced to the second position from a position of FIG. 3.

FIG. 11 is a front view in which the cover is displaced to the second position from a position of FIG. 7.

FIG. 12 is a side view before the first and second connectors are assembled.

FIG. 13 is a side view after the first and second connectors are assembled.

### DETAILED DESCRIPTION TO EXECUTE THE INVENTION

### Description of Embodiments of Present Disclosure

First, embodiments of the present disclosure are listed and described.

[1] The connector of the present disclosure is provided with a housing having a facing surface facing a mating connector when the connector is assembled with the mating connector, a terminal held in the housing, the terminal projecting in a first direction from the facing surface, and a cover to be held on the housing, wherein the housing includes a peripheral wall projecting in the first direction from the facing surface and provided to surround the terminal when viewed from a second direction opposite to the first direction and a connection opening formed by the peripheral wall surrounding the terminal when viewed from the second direction, the peripheral wall is provided with an exposure opening communicating with the connection opening and configured to expose inside of the housing, and the cover is provided to be displaced between a first position where the cover closes the connection opening and the exposure opening and a second position where the cover is retracted from the connection opening and the exposure opening.

According to the above configuration, the cover is located at the second position when the connector and the mating connector are assembled, thereby reducing a possibility of interference of the cover with the mating connector. On the other hand, when the connector and the mating connector are not assembled, the cover is located at the first position, thereby closing the connection opening and the exposure opening. A possibility that worker's fingers touch the terminal is reduced by the cover closing the connection opening and the exposure opening.

Here, “facing each other” in this specification indicates that surfaces or members are at positions right in front of each other and means not only a case where the surfaces or members are at positions perfectly in front of each other, but also a case where the surfaces or members are at positions partially in front of each other. Further, “facing each other” in this specification means both a case where another member different from two members is interposed between the two members and a case where nothing is present between the two members.

[2] Preferably, in the connector, the cover includes a first cover member, a second cover member to be coupled to the first cover member, a first shaft member to be mounted on the housing and the first cover member, and a second shaft member to be mounted on the first cover member and the second cover member, the cover is displaced between the first position and the second position by the first cover member rotating about the first shaft member and the second cover member rotating about the second shaft member, the first cover member closes the exposure opening when the cover is located at the first position and is retracted from the exposure opening when the cover is located at the second position, and the second cover member closes the connection opening when the cover is located at the first position and is retracted from the connection opening when the cover is located at the second position.

According to the above configuration, the cover configured to be displaced between the first position and the second position can be relatively easily configured.

[3] Preferably, in the connector, the cover includes a first pressing member configured to contact the housing and the first cover member and a second pressing member configured to contact the first cover member and the second cover member, the first and second pressing members respectively press the first and second cover members such that the cover is displaced to the first position, and the cover is provided to be displaced to the second position by the second cover member being pressed by the mating connector when the connector and the mating connector are assembled.

According to the above configuration, the cover is displaced to the second position as the connector and the mating connector are assembled. The cover is displaced to the first position as the connector and the mating connector are disassembled. In this way, a possibility that the cover is inadvertently displaced to the second position is reduced. That is, since it becomes difficult to access the inside of the housing through the connection opening and the exposure opening, a possibility that worker's fingers touch the terminal is reduced.

[4] Preferably, in the connector, the housing includes a mounting portion, the cover being mounted on the mounting portion, the peripheral wall includes a first wall provided with the exposure opening and the mounting portion and a second wall facing the first wall, and a tip of the peripheral wall is so provided that a projection amount of the peripheral wall projecting from the facing surface decreases from the second wall toward the first wall.

According to the above configuration, the mating connector first contacts the second cover member when the connector and the mating connector are assembled. Since the tip of the peripheral wall is so provided that the projection amount of the peripheral wall decreases from the second wall toward the first wall, the second cover member is displaced while sliding on the tip of the peripheral wall by being pressed by the mating connector. In this way, the second cover member is retracted from the connection opening.

Since the first cover member is coupled to the second cover member, the first cover member is retracted from the exposure opening as the second cover member is retracted from the connection opening. In this way, the cover can be displaced from the first position to the second position as the connector and the mating connector are assembled.

[5] Preferably, in the connector, the first wall includes a projecting part projecting in the first direction from the facing surface, and the exposure opening is so provided in the first wall that a tip of the projecting part serves as an edge.

Normally, the mating connector to be assembled with such a connector includes a sealing member for sealing between the connector and the mating connector by contacting the peripheral wall when the connector and the mating connector are assembled. By holding the sealing member and the peripheral wall in close contact with each other, sealability between the connector and the mating connector is ensured.

According to the above configuration, sealability between the connector and the mating connector is ensured by the contact of the sealing member with the peripheral wall including the projecting part when the connector and the mating connector are assembled. If the exposure opening is provided from a tip to a base end of the first wall, the sealing member has a part not to be brought into contact with the peripheral wall, wherefore it becomes difficult to ensure sealability.

[6] Preferably, in the connector, the housing includes a protecting portion configured to protect the terminal, and the protecting portion projects in the first direction from the facing surface and is provided to surround the terminal in a region surrounded by the peripheral wall when the housing is viewed from the second direction.

According to the above configuration, a possibility that worker's fingers touch the terminal is reduced by the protecting portion surrounding the terminal.

### Details of Embodiment of Present Disclosure

### Embodiment

One embodiment of an electrical connection device provided with a connector of the present disclosure is described below with reference to the drawings. The electrical connection device of this embodiment is used in a connection part in a wiring harness for a high-voltage power supply of a vehicle. Note that the present invention is not limited to these illustrations and is intended to be represented by claims and include all changes in the scope of claims and in the meaning and scope of equivalents.

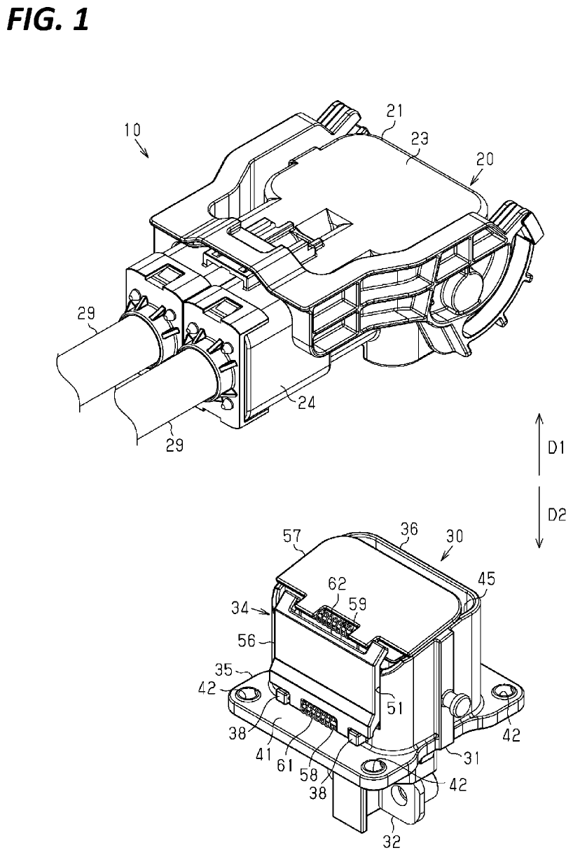

As shown in FIG. 1, an electrical connection device 10 includes a first connector 20 and a second connector 30. The first and second connectors 20, 30 are assembled with each other. The first and second connectors 20, 30 are electrically connected by being assembled with each other.

In this embodiment, a direction in which the second connector 30 relatively approaches the first connector 20 in the case of assembling the first and second connectors 20, 30 is referred to as a first direction D1. Further, a direction in which the first connector 20 relatively approaches the second connector 30 in the case of assembling the first and second connectors 20, 30 is referred to as a second direction D2. That is, the first and second directions D1, D2 are mutually opposite directions.

(First Connector 20)

First, the first connector 20 is described.

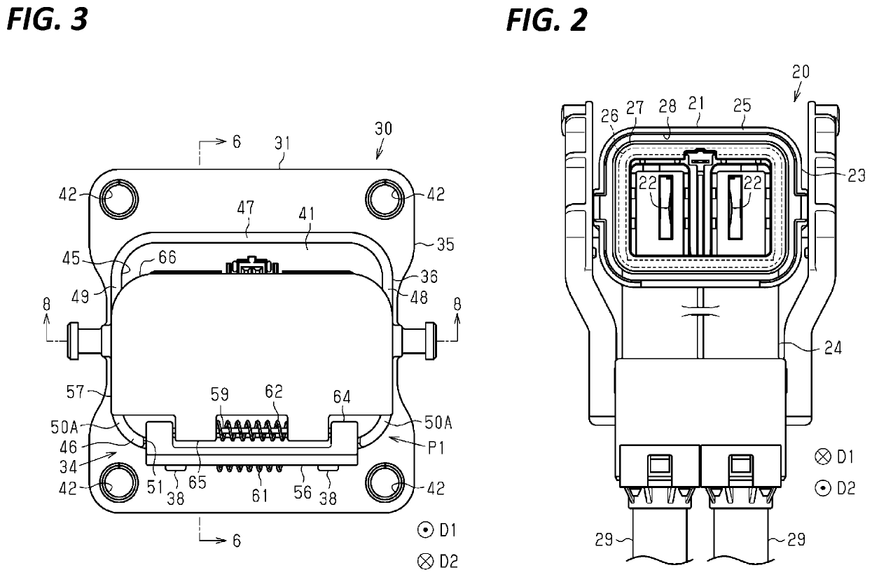

As shown in FIG. 2, the first connector 20 includes a first housing 21 and first terminals 22. The first connector 20 is a mating connector of the second connector 30.

The first housing 21 is a housing provided in the first connector 20. The first housing 21 holds the first terminals 22.

The first housing 21 includes a first accommodating portion 23 and a second accommodating portion 24. The first and second accommodating portions 23, 24 accommodate the first terminals 22. Thus, the inside of the first accommodating portion 23 and that of the second accommodating portion 24 communicate.

The first accommodating portion 23 includes an outer peripheral wall 25, an inner peripheral wall 26 and a sealing member 27.

The outer peripheral wall 25 is provided to have a rectangular shape when the first housing 21 is viewed from the first direction D1. Thus, the first accommodating portion 23 includes an accommodation opening 28 formed by the outer peripheral wall 25. The accommodation opening 28 is an opening formed in the first housing 21. The accommodation opening 28 is facing in the second direction D2 in the first housing 21. The first accommodating portion 23 of this embodiment accommodates a part of the second connector 30 through the accommodation opening 28 when the first and second connectors 20, 30 are assembled.

The inner peripheral wall 26 is provided in a region surrounded by the outer peripheral wall 25. Thus, the inner peripheral wall 26 is provided to have a rectangular shape one size smaller than the shape of the outer peripheral wall 25 when the first housing 21 is viewed from the first direction D1.

The sealing member 27 is provided on the tip of the inner peripheral wall 26. Thus, the sealing member 27 is provided to have a rectangular shape when the first housing 21 is viewed from the first direction D1. The sealing member 27 is, for example, made of a resilient material such as rubber or elastomer. The sealing member 27 contacts the second connector 30 when the first and second connectors 20, 30 are assembled. The sealing member 27 seals between the first and second connectors 20, 30 by contacting the second connector 30. In this way, sealability between the first and second connectors 20, 30 is ensured.

The second accommodating portion 24 accommodates parts of wires 29 connected to the first terminals 22. The second accommodating portion 24 is provided to extend from the outer peripheral wall 25. Specifically, the second accommodating portion 24 extends in a direction different from the first and second directions D1, D2 from one surface of the outer peripheral wall 25. Thus, a connecting direction of the first connector 20 to the second connector 30 and an extending direction of the wires 29 from the first connector 20 are different in the first connector 20. That is, the first connector 20 is an L-shaped connector bent between an input side and an output side.

The first terminal 22 is a terminal provided in the first connector 20. Two first terminals 22 are provided. The two first terminals 22 are respectively connected to two wires 29 in the first housing 21. By assembling the first and second connectors 20, 30, the first terminals 22 are electrically connected to the second connector 30.

(Second Connector 30)

Next, the second connector 30 is described.

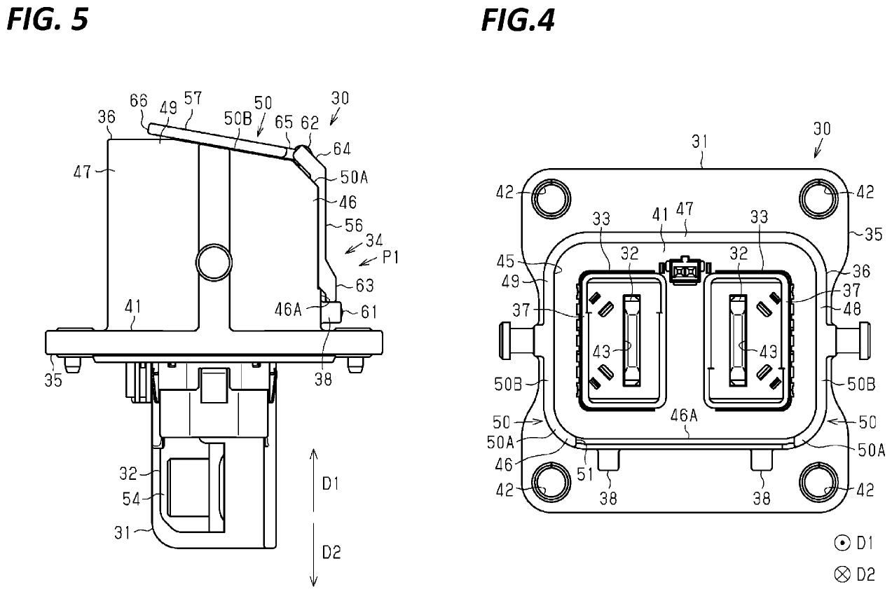

As shown in FIGS. 3 and 4, the second connector 30 includes a second housing 31, second terminals 32, shield members 33 and a cover 34. The second connector 30 is a mating connector of the first connector 20. The first connector 20 is a mating connector of the second connector 30.

(Second Housing 31)

The second housing 31 is a housing provided in the second connector 30. The second housing 31 holds the second terminals 32, the shield members 33 and the cover 34. The second housing 31 includes a fixing portion 35, a peripheral wall 36, protecting portions 37 and mounting portions 38.

The fixing portion 35 is, for example, plate-like. The fixing portion 35 of this embodiment is provided to have a rectangular shape when the second housing 31 is viewed from the second direction D2. The fixing portion 35 has a facing surface 41, fixing holes 42 and insertion holes 43.

The facing surface 41 is a surface facing the first connector 20 when the second connector 30 is assembled with the first connector 20. Thus, the facing surface 41 is a surface facing the first connector 20 in the fixing portion 35. The facing surface 41 is facing the first connector 20 in the fixing portion 35. That is, the facing surface 41 is facing in the first direction D1 in the fixing portion 35.

One or more fixing holes 42 are provided. In this embodiment, four fixing holes 42 are provided. The four fixing holes 42 are located on four corners of the fixing portion 35 when the second housing 31 is viewed from the second direction D2. The fixing holes 42 are, for example, holes into which bolts, screws or the like are inserted. By inserting bolts, screws or the like into the fixing holes 42, the fixing portion 35 is fixed to another member. As a result, the second housing 31 is mounted on another member.

The insertion hole 43 is a hole for insertion of the second terminal 32. Two insertion holes 43 are, for example, provided. The insertion holes 43 penetrate through the fixing portion 35. The insertion holes 43 of this embodiment are in the form of slits open in the facing surface 41.

The peripheral wall 36 is provided to extend in the first direction D1 from the fixing portion 35. Specifically, the peripheral wall 36 projects in the first direction D1 from the facing surface 41. The peripheral wall 36 is provided to surround the insertion holes 43 in the facing surface 41 when the second housing 31 is viewed from the second direction D2. In particular, the peripheral wall 36 is provided to surround the second terminals 32 when the second housing 31 is viewed from the second direction D2. The peripheral wall 36 is inserted between the outer peripheral wall 25 and the sealing member 27 when the first and second connectors 20, 30 are assembled. At this time, the peripheral wall 36 is held in close contact with the sealing member 27.

The peripheral wall 36 of this embodiment is provided to have a rectangular shape when the second housing 31 is viewed from the second direction D2. Thus, the second housing 31 includes a connection opening 45 formed by the peripheral wall 36.

The connection opening 45 is formed by the peripheral wall 36 surrounding the second terminals 32. The connection opening 45 is an opening formed in the second housing 31. The connection opening 45 is facing in the first direction D1 in the second housing 31. That is, in the second housing 31, a direction facing the connection opening 45 from the facing surface 41 is the first direction D1 and a direction facing the facing surface 41 from the connection opening 45 is the second direction D2. The second connector 30 is connected to the first connector 20 through the connection opening 45.

The peripheral wall 36 includes a first wall 46, a second wall 47, a third wall 48 and a fourth wall 49. The first, second, third and fourth walls 46, 47, 48 and 49 are provided to surround the second terminals 32 on four sides when the second housing 31 is viewed from the second direction D2.

The first and second walls 46, 47 are facing each other. The third and fourth walls 48, 49 are facing each other. The first wall 46 is connected to the third and fourth walls 48, 49. The second wall 47 is connected to the third and fourth walls 48, 49. The third wall 48 is connected to the first and second walls 46, 47. The fourth wall 49 is connected to the first and second walls 46, 47.

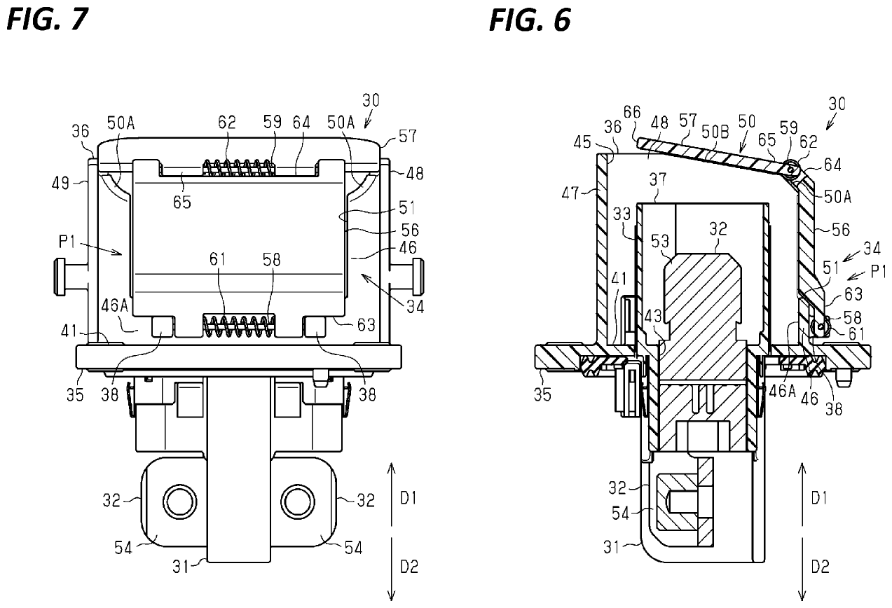

As shown in FIGS. 5 and 6, the peripheral wall 36 is so provided that the tip thereof is inclined with respect to the second direction D2 from the second wall 47 to the first wall 46. That is, the tip of the peripheral wall 36 is so provided that a projection amount of the peripheral wall 36 projecting from the facing surface 41 decreases from the second wall 47 toward the first wall 46. In this embodiment, the tip of the peripheral wall 36 is so inclined that the projection amount of the peripheral wall 36 decreases from the second wall 47 toward the first wall 46. In particular, a projection amount of the first wall 46 is smaller than that of the second wall 47. The tips of the third and fourth walls 48, 49 are so inclined that projection amounts thereof decrease from the second wall 47 toward the first wall 46. In this embodiment, the tip of the first wall 46 is continuously inclined with respect to the tips of the third and fourth walls 48, 49. In this way, the peripheral wall 46 has an inclined surface 50 on the tip thereof.

In this embodiment, the inclined surface 50 includes first inclined surfaces 50A and second inclined surfaces 50B having different degrees of inclination with respect to the facing surface 41. The first inclined surfaces 50A are provided on the tips of the first wall 46, the third wall 48 and the fourth wall 49. The second inclined surfaces 50B are continuous with the first inclined surfaces 50A and provided on the tips of the third wall 48 and the fourth wall 49. The tip of the peripheral wall 36 is so inclined that a downward gradient with respect to the facing surface 41 increases in a stepwise manner from the second wall 47 toward the first wall 46 by the first and second inclined surfaces 50A, 50B. In other words, the tip of the peripheral wall 36 is so inclined that a gradient toward the facing surface 41 increases in a stepwise manner from the second wall 47 toward the first wall 46 by the first and second inclined surfaces 50A, SOB.

As shown in FIGS. 4, 6 and 7, the first wall 46 is provided with an exposure opening 51. That is, the exposure opening 51 is provided in the peripheral wall 36. The exposure opening 51 is an opening for exposing the inside of the second housing 31. The exposure opening 51 of this embodiment is provided to have a rectangular shape when the first wall 46 is viewed from front.

The exposure opening 51 communicates with the connection opening 45. The exposure opening 51 is provided to avoid the interference of the first and second housings 21, 31 in the case of assembling the first and second connectors 20, 30. That is, the first housing 21 is fit into the exposure opening 51 in the case of assembling the first and second connectors 20, 30. The exposure opening 51 is necessary since the first connector 20 is an L-shaped connector.

The exposure opening 51 is provided at a position of the first wall 46 separated in the first direction D1 from the facing surface 41. That is, the exposure opening 51 is provided not from the tip to the base end of the first wall 46, but from the tip of the first wall 46 to a position between the tip and the base end. Thus, the first wall 46 includes a projecting part 46A projecting in the first direction D1 from the facing surface 41. The exposure opening 51 is so provided in the first wall 46 that the tip of the projecting part 46A serves an edge.

The projecting part 46A contacts the sealing member 27 when the first and second connectors 20, 30 are assembled. The sealing member 27 can contact the peripheral wall 36 over an entire periphery by the first wall 46 including the projecting part 46A. That is, sealability between the first and second connectors 20, 30 is ensured by the projecting part 46A. If the exposure opening 51 is provided from the tip to the base end of the first wall 46, i.e. if the first wall 46 does not include the projecting part 46A, the sealing member 27 has a part not to be brought into contact with the peripheral wall 36. In this case, it is difficult to ensure sealability.

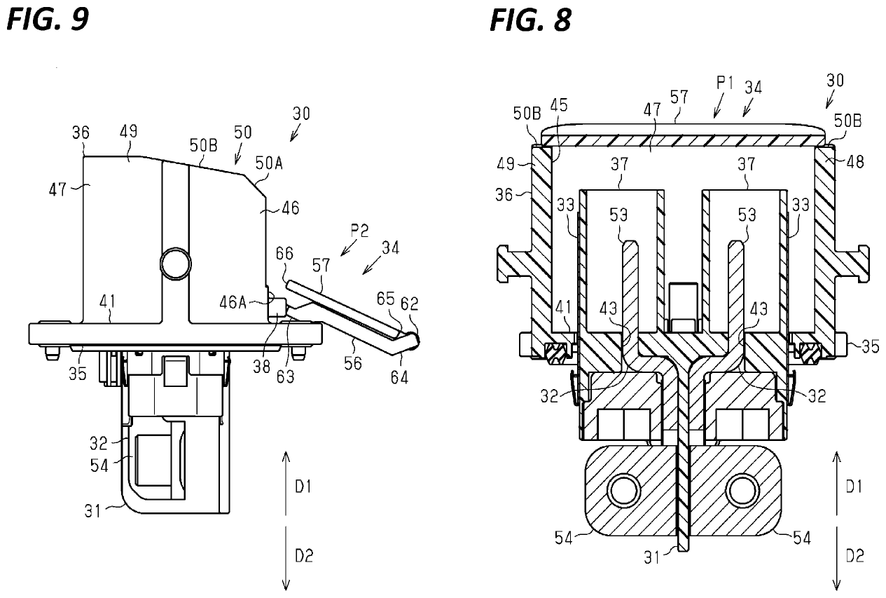

As shown in FIGS. 4 and 8, the protecting portion 37 is, for example, plate-like. The protecting portion 37 is provided to extend in the first direction D1 from the fixing portion 35. Specifically, the protecting portion 37 projects in the first direction D1 from the facing surface 41. A projection amount of the protecting portion 37 is smaller than that of the peripheral wall 36. Thus, a distance between the tip of the protecting portion 37 and the facing surface 41 is shorter than a distance between the tip of the peripheral wall 36 and the facing surface 41.

The protecting portion 37 is provided in a region surrounded by the peripheral wall 36 in the facing surface 41. The protecting portion 37 is provided to surround the second terminal 32 when the second housing 31 is viewed from the second direction D2. The protecting portion 37 protects the second terminal 32 by surrounding the second terminal 32. In this embodiment, the protecting portion 37 is provided to surround the second terminal 32 when the second housing 31 is viewed from the second direction D2. For example, the protecting portion 37 is provided to surround the second terminal 32 on four sides when the second housing 31 is viewed from the second direction D2. Thus, the protecting portion 37 of this embodiment is provided to extend around the second terminal 32 while being bent when the second housing 31 is viewed from the second direction D2. The protecting portion 37 protects the second terminal 32 by surrounding the second terminal 32. Particularly, the protecting portion 37 reduces a possibility that worker's fingers touch the second terminal 32 by protecting the second terminal 32.

In this embodiment, two protecting portions 37 are provided. The two protecting portions 37 are provided to respectively surround the two insertion holes 43. The two protecting portions 37 are provided side by side between the third and fourth walls 48, 49. In this embodiment, the two protecting portions 37 are respectively provided to have a rectangular shape when the second housing 31 is viewed from the second direction D2. In this embodiment, the two protecting portions 37 are provided symmetrically with respect to a center of the facing surface 41 when the second housing 31 is viewed from the second direction D2.

As shown in FIGS. 4 and 5, the mounting portions 38 are so configured that the cover 34 is mounted thereon. The mounting portions 38 are, for example, mounted on the peripheral wall 36. The mounting portions 38 of this embodiment are provided on the first wall 46. More specifically, the mounting portions 38 are provided on the projecting part 46A. The mounting portions 38 hold the mounted cover 34. In this way, the second housing 31 holds the cover 34.

The mounting portions 38 project from the outer peripheral surface of the peripheral wall 36. That is, the mounting portions 38 are provided outside a region surrounded by the peripheral wall 36 when the second housing 31 is viewed from the second direction D2. The mounting portions 38 of this embodiment are provided to project outwardly of the peripheral wall 36 from the first wall 46 when the second housing 31 is viewed from the second direction D2. In this embodiment, two mounting portions 38 are provided. The two mounting portions 38 are provided at a predetermined distance from each other.

(Second Terminals 32)

As shown in FIGS. 4 and 8, the second terminal 32 is, for example, a busbar. The second terminal 32 is held in the second housing 31. Two second terminals 32 are provided. The two second terminals 32 are respectively inserted into the two insertion holes 43. Thus, the two second terminals 32 are respectively passed through the fixing portion 35. Each of the two second terminals 32 includes a first part 53 and a second part 54.

The first part 53 is a part to be connected to the first connector 20 in the second terminal 32. That is, the first part 53 contacts the first terminal 22 in the case of assembling the first and second connectors 20, 30.

The first part 53 is accommodated into the second housing 31. The first part 53 extends in the first direction D1 from the facing surface 41 by inserting the second terminal 32 into the insertion hole 43. Thus, the second terminal 32 can be said to project in the first direction D1 from the facing surface 41. A projection amount of the first part 53 is smaller than that of the protecting portion 37. That is, a projection amount of the second terminal 32 is smaller than that of the protecting portion 37. Thus, a distance between the tip of the second terminal 32 and the facing surface 41 is shorter than the distance between the tip of the protecting portion 37 and the facing surface 41.

The two first parts 53 are provided side by side between the third and fourth walls 48, 49. In this embodiment, the two first parts 53 are provided in parallel to the third and fourth walls 48, 49. The two first parts 53 are respectively provided to be surrounded by the two protecting portions 37.

Here, “parallel” in this specification means not only strictly parallel, but also substantially parallel within a range in which functions and effects in this embodiment are achieved.

The second part 54 is, for example, a part to be connected to an unillustrated wire in the second terminal 32. Two second parts 54 are respectively connected to unillustrated two wires. The second part 54 protrudes out from the second housing 31. The second part 54 is provided on a side opposite to the peripheral wall 36 with respect to the fixing portion 35. The second part 54 is provided to extend in the second direction D2 from the fixing portion 35.

(Shield Members 33)

The shield member 33 is made of metal. The shield member 33 is, for example, a plate-like member. The shield member 33 is held in the second housing 31. The shield member 33 is provided along the protecting portion 37. Thus, the shield member 33 of this embodiment is provided along the protecting portion 37 while being bent when the second housing 31 is viewed from the second direction D2. The shield member 33 of this embodiment is provided between the protecting portion 37 and the peripheral wall 36 and mounted on the protecting portion 37.

The shield member 33 is provided to surround the second terminal 32, similarly to the protecting portion 37. A possibility that the second terminal 32 is affected by noise is reduced by the shield member 33 surrounding the second terminal 32. Further, the strength of the protecting portion 37 is improved by the shield member 33.

The shield member 33 of this embodiment is provided to partially surround the second terminal 32 when the second housing 31 is viewed from the second direction D2. The shield member 33 is provided to surround the second terminal 32 on three sides when the second housing 31 is viewed from the second direction D2. Thus, the shield member 33 of this embodiment is provided partially along the protecting portion 37.

In this embodiment, two shield members 33 are provided. The two shield members 33 are respectively provided along the two protecting portions 37. In this embodiment, one of the two shield members 33 is provided to have a C shape and the other is provided to have an inverted C shape when the second housing 31 is viewed from the second direction D2.

(Cover 34) As shown in FIGS. 3 and 7, the cover 34 is held on the second housing 31. The cover 34 protects the second terminals 32. The cover 34 includes a first cover member 56, a second cover member 57, a first shaft member 58 and a second shaft member 59. The cover 34 of this embodiment further includes a first pressing member 61 and a second pressing member 62.

The first cover member 56 is a member for protecting the second terminals 32. The first cover member 56 is, for example, a plate-like member. The first cover member 56 is mounted on the mounting portions 38. In this way, the first cover member 56 is held on the second housing 31. The first cover member 56 is mounted on the mounting portions 38 via the first shaft member 58. The first cover member 56 rotates about the first shaft member 58. The first cover member 56 is displaced by being rotated.

The first cover member 56 includes a first end part 63, in which the first shaft member 58 is mounted, and a second end part 64 opposite to the first end part 63. The first end part 63 is mounted on the mounting portions 38 via the first shaft member 58. The first end part 63 is so provided that the first shaft member 58 is inserted therethrough. The first end part 63 holds the first shaft member 58 by having the first shaft member 58 inserted therethrough. The second end part 64 is coupled to the second cover member 57. The second end part 64 is coupled to the second cover member 57 via the second shaft member 59. The second end part 64 is so provided that the second shaft member 59 is inserted therethrough. The second end part 64 holds the second shaft member 59 by having the second shaft member 59 inserted therethrough. The second end part 64 holds, for example, both ends of the second shaft member 59.

The second cover member 57 is a member for protecting the second terminals 32. The second cover member 57 is, for example, a plate-like member. The second cover member 57 is coupled to the first cover member 56. In this way, the second cover member 57 is held on the second housing 31. The second cover member 57 is coupled to the first cover member 56 via the second shaft member 59. The second cover member 57 rotates about the second shaft member 59. The second cover member 57 is displaced by being rotated.

The second cover member 57 includes a third end part 65, in which the second shaft member 59 is mounted, and a fourth end part 66 opposite to the third end part 65. The third end part 65 is coupled to the second end part 64 via the second shaft member 59. The third end part 65 is so provided that the second shaft member 59 is inserted therethrough. The third end part 65 holds the second shaft member 59 by having the second shaft member 59 inserted therethrough.

The first shaft member 58 is mounted on the second housing 31 and the first cover member 56. In particular, the first shaft member 58 is mounted on the mounting portions 38 and the first end part 63. Both ends of the first shaft member 58 are held by the two mounting portions 38.

The second shaft member 59 is mounted on the first cover member 56 and the second cover member 57. In particular, the second shaft member 59 is mounted on the second end part 64 and the third end part 65. Both ends of the second shaft member 59 are held by the third end part 65.

The first pressing member 61 is, for example, a coil spring. In this case, the first shaft member 58 is inserted through the first pressing member 61. In this way, the first pressing member 61 is mounted on the first shaft member 58. The first pressing member 61 contacts the second housing 31 and the first cover member 56. The first pressing member 61 contacts, for example, the fixing portion 35 and the first end part 63. The first pressing member 61 presses the first cover member 56 against the second housing 31.

The second pressing member 62 is, for example, a coil spring. In this case, the second shaft member 59 is inserted through the second pressing member 62. In this way, the second pressing member 62 is mounted on the second shaft member 59. The second pressing member 62 contacts the first cover member 56 and the second cover member 57. The second pressing member 62 contacts, for example, the second end part 64 and the third end part 65. The first pressing member 61 presses the second cover member 57 against the first cover member 56.

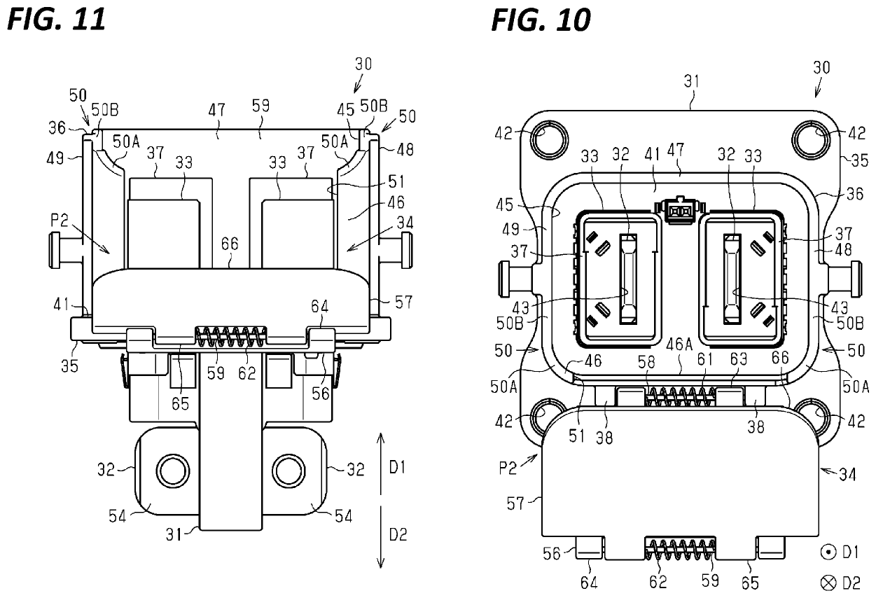

As shown in FIGS. 3, 5, 7, 9, 10 and 11, the cover 34 is configured to be displaced between a first position P1 where the cover 34 closes the connection opening 45 and the exposure opening 51 and a second position P2 where the cover 34 is retracted from the connection opening 45 and the exposure opening 51. In this embodiment, the cover 34 is displaced between the first position P1 and the second position P2 by displacements of the first and second cover members 56, 57. That is, the cover 34 of this embodiment is displaced between the first position P1 and the second position P2 by the first cover member 56 rotating about the first shaft member 58 and the second cover member 57 rotating about the second shaft member 59.

The cover 34 closes and opens the connection opening 45 and the exposure opening 51 by displacements of the first and second cover members 56, 57. The connection opening 45 and the exposure opening 51 are closed if the cover 34 is closed. The connection opening 45 and the exposure opening 51 are exposed if the cover 34 is opened. The cover 34 shown in FIGS. 3, 5 and 7 is located at the first position P1. The cover 34 shown in FIGS. 9, 10 and 11 is located at the second position P2.

The first cover member 56 is displaced between a position where the first cover member 56 closes the exposure opening 51 and a position where the first cover member 56 is retracted from the exposure opening 51. Thus, the first cover member 56 closes the exposure opening 51 when the cover 34 is located at the first position P1, and is retracted from the exposure opening 51 when the cover 34 is located at the second position P2. The first cover member 56 contacts the first wall 46 in the case of closing the exposure opening 51. The first cover member 56 contacts the fixing portion 35 in the case of being retracted from the exposure opening 51.

The second cover member 57 is displaced between a position where the second cover member 57 closes the connection opening 45 and a position where the second cover member 57 is retracted from the connection opening 45. Thus, the second cover member 57 closes the connection opening 45 when the cover 34 is located at the first position P1, and is retracted from the connection opening 45 when the cover 34 is located at the second position P2. The second cover member 57 contacts the inclined surface 50 in the case of closing the connection opening 45. In this embodiment, the second cover member 57 contacts the second inclined surfaces SOB in the case of closing the connection opening 45. The second cover member 57 is separated from the inclined surface 50 in the case of being retracted from the connection opening 45. The second cover member 57 is also retracted from the exposure opening 51 in the case of being retracted from the connection opening 45.

The second cover member 57 is located to be folded with respect to the first cover member 56 when the cover 34 is located at the second position P2. At this time, the second cover member 57 is so located that the fourth end part 66 and the first end part 63 overlap.

The first pressing member 61 presses the first cover member 56 such that the cover 34 is displaced to the first position P1. Specifically, the first pressing member 61 presses the first cover member 56 such that the first cover member 56 closes the exposure opening 51. That is, the first pressing member 61 presses the first cover member 56 toward the first wall 46. The first pressing member 61 presses the first cover member 56 in a counterclockwise direction in FIGS. 5 and 9 with respect to the second housing 31.

The second pressing member 62 presses the second cover member 57 such that the cover 34 is displaced to the first position P1. Specifically, the second pressing member 62 presses the second cover member 57 such that the second cover member 57 closes the connection opening 45. That is, the second pressing member 62 presses the second cover member 57 such that the fourth end part 66 approaches the first end part 63. The second pressing member 62 presses the second cover member 57 in the counterclockwise direction in FIGS. 5 and 9 with respect to the first cover member 56. A force of the second pressing member 62 for pressing the second cover member 57 is smaller than that of the first pressing member 61 for pressing the first cover member 56.

As described above, the first and second pressing members 61, 62 respectively press the first and second cover members 56, 57 such that the cover 34 is displaced to the first position P1. Thus, the cover 34 is normally located at the first position P1. For example, the cover 34 is located at the first position P1 when the first and second connectors 20, 30 are not assembled. In contrast, when the first and second connectors 20, 30 are assembled, the cover 34 is displaced to the second position P2 by being pressed by the first connector 20. This point will be described later.

(Movements of Cover 34)

Next, movements of the cover 34 are described.

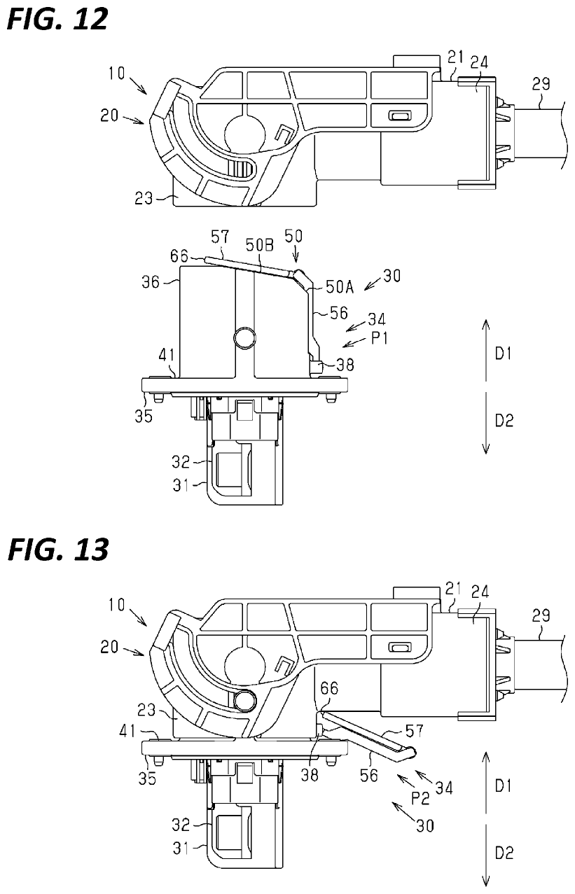

As shown in FIG. 12, the cover 34 is located at the first position P1 before the first and second connectors 20, 30 are assembled, i.e. when the first and second connectors 20, 30 are not assembled. This is because the first and second cover members 56, 57 are respectively pressed by the first and second pressing members 61, 62 such that the cover 34 is displaced to the first position P1 as described above.

If the first connector 20 approaches the second connector 30, the first housing 21 contacts the cover 34. Specifically, the first connector 20 moves in the second direction D2 with respect to the second connector 30, whereby the first accommodating portion 23 first contacts the second cover member 57. Since the inclined surface 50 is provided on the tip of the peripheral wall 36, the first accommodating portion 23 first contacts the fourth end part 66 of the second cover member 57.

If the first connector 20 further moves in the second direction D2, the second cover member 57 is displaced along the inclined surface 50 by being pressed in the second direction D2 by the first connector 20. At this time, the second cover member 57 is displaced while the fourth end part 66 is contacting the first inclined surfaces 50A and the second inclined surfaces SOB. In this way, the second cover member 57 is displaced to be pushed away from the connection opening 45.

If the first connector 20 further moves in the second direction D2, the second cover member 57 is displaced while the fourth end part 66 is contacting the edge of the exposure opening 51 in the first wall 46. At this time, the fourth end part 66 approaches the first end part 63 by being displaced in the second direction D2 while contacting the edge of the exposure opening 51 in the first wall 46. By being pressed by the first connector 20 in this way, the second cover member 57 is displaced to be folded with respect to the first cover member 56. On the other hand, the first cover member 56 is displaced to be retracted from the exposure opening 51 as the second cover member 57 is displaced. That is, the first cover member 56 is separated from the first wall 46 and approaches the fixing portion 35.

As shown in FIG. 13, if the first and second connectors 20, 30 are assembled, the cover 34 is displaced to the second position P2. At this time, the fourth end part 66 is separated from the first wall 46. If the cover 34 is displaced to the second position P2, the connection opening 45 and the exposure opening 51 are exposed. If the first and second connectors 20, 30 are assembled, the first housing 21 is fit into the exposure opening 51. That is, when the first and second connectors 20, 30 are assembled, the cover 34 is retracted from the exposure opening 51, thereby not hindering the assembling of the first and second connectors 20, 30.

If the first and second connectors 20, 30 are disassembled, the cover 34 is displaced toward the first position P1 by the first and second pressing members 61, 62. If the first and second connectors 20, 30 are disassembled, the fourth end part 66 first contacts the first wall 46. At this time, the second cover member 57 contacts the first wall 46 at an acute angle. In particular, the second cover member 57 contacts the first wall 46 such that an angle on a base end side of the peripheral wall 36, out of two angles with respect to the first wall 46, is an acute angle. Further, since the pressing force of the first pressing member 61 is stronger than the pressing force of the second pressing member 62, the fourth end part 66 is displaced in the first direction D1 along the first wall 46. In this way, the second cover member 57 is displaced to be opened with respect to the first cover member 56 from a folded state. As a result, the cover 34 is displaced to the first position P1.

Next, functions and effects of this embodiment are described.

(1) The cover 34 is provided to be displaced between the first position P1 where the cover 34 closes the connection opening 45 and the exposure opening 51 and the second position P2 where the cover 34 is retracted from the connection opening 45 and the exposure opening 51.

According to the above configuration, when the first and second connectors 20, 30 are assembled, the cover 34 is located at the second position P2, thereby reducing a possibility of interference of the cover 34 with the second connector 30. On the other hand, when the first and second connectors 20, 30 are not assembled, the cover 34 is located at the first position P1, thereby closing the connection opening 45 and the exposure opening 51. By the cover 34 closing the connection opening 45 and the exposure opening 51, a possibility that worker's fingers touch the second terminals 32 is reduced.

(2) The cover 34 is displaced between the first position P1 and the second position P2 by the first cover member 56 rotating about the first shaft member 58 and the second cover member 57 rotating about the second shaft member 59.

According to the above configuration, the cover 34 configured to be displaced between the first position P1 and the second position P2 can be relatively easily configured.

(3) The first and second pressing members 61, 62 press the first and second cover members 56, 57 such that the cover 34 is displaced to the first position P1. The cover 34 is provided to be displaced to the second position P2 by the second cover member 57 being pressed by the second connector 30 when the first and second connectors 20, 30 are assembled.

According to the above configuration, the cover 34 is displaced to the second position P2 as the first and second connectors 20, 30 are assembled. The cover 34 is displaced to the first position P1 as the first and second connectors 20, 30 are disassembled. In this way, a possibility that the cover 34 is inadvertently displaced to the second position P2 is reduced. That is, since it becomes difficult to access the inside of the second housing 31 through the connection opening 45 and the exposure opening 51, a possibility that worker's fingers touch the second terminals 32 is reduced.

(4) The tip of the peripheral wall 36 is so provided that the projection amount of the peripheral wall 36 projecting from the facing surface 41 decreases from the second wall 47 toward the first wall 46.

According to the above configuration, when the first and second connectors 20, 30 are assembled, the first connector 20 first contacts the second cover member 57. Since the tip of the peripheral wall 36 is so provided that the projection amount of the peripheral wall 46 projecting from the facing surface 41 decreases from the second wall 47 toward the first wall 46, the second cover member 57 is displaced while sliding on the tip of the peripheral wall 36 by being pressed by the first connector 20. In this way, the second cover member 57 is retracted from the connection opening 45.

Since the first cover member 56 is coupled to the second cover member 57, the first cover member 56 is retracted from the exposure opening 51 as the second cover member 57 is retracted from the connection opening 45. In this way, the cover 34 can be displaced from the first position P1 to the second position P2 as the first and second connectors 20, 30 are assembled.

(5) The exposure opening 51 is so provided in the first wall 46 that the tip of the projecting part 46A serves as an edge.

According to the above configuration, the sealing member 27 contacts the peripheral wall 36 including the projecting part 46A when the first and second connectors 20, 30 are assembled, whereby sealability between the first and second connectors 20, 30 is ensured. If the exposure opening 51 is provided from the tip to the base end of the first wall 46, the sealing member 27 has a part not to be brought into contact with the peripheral wall 36. Thus, it is difficult to ensure sealability.

(6) The pressing portions 37 are provided to surround the second terminals 32 in the region surrounded by the peripheral wall 36 when the second housing 31 is viewed from the second direction D2.

According to the above configuration, a possibility that worker's fingers touch the second terminals 32 is reduced by the pressing portions 37 surrounding the second terminals 32.

(7) When the first and second connectors 20, 30 are not assembled, the first cover member 56 closes the exposure opening 51, whereby the strength of the peripheral wall 36 is improved.

### Modifications

The above embodiment can be modified and carried out as follows. The above embodiment and the following modifications can be carried out in combination without technically contradicting each other.
The first cover member 56 may be displaced between the position where the first cover member 56 closes the exposure opening 51 and the position where the first cover member 56 is retracted from the exposure opening 51, for example, by sliding without being limited to being displaced between the two positions by rotating.
The first pressing member 61 may be, for example, a leaf spring without being limited to a coil spring.
The second pressing member 62 may be, for example, a leaf spring without being limited to a coil spring.
Instead of the inclined surface 50, a curved surface may be provided on the tip of the peripheral wall 36. This curved surface is a surface curved in the second direction D2 from the second wall 47 toward the first wall 46.
Instead of providing the inclined surface 50 on the peripheral wall 36, an inclined or curved surface may be provided on the tip of the outer peripheral wall 25. That is, the outer peripheral wall 25 may have a shape such as a curved or inclined surface to push away the second cover member 57 when the first and second connectors 20, 30 are assembled.
The cover 34 may be displaced between the first position P1 and the second position P2, for example, by the operation of a worker without depending on the assembling of the first and second connectors 20, 30.
The first and second cover members 56, 57 may be respectively independently provided without being limited to those coupled to each other. In this case, the second cover member 57 can close the connection opening 45 without depending on the position of the first cover member 56.
As shown by cross-section hatching in FIGS. 6 and 8, the second housing 31 may be made of resin, possibly insulating resin, and the second terminals may be metal. The second housing 31 may be configured as a one-piece article as in a shown example.
The facing surface 41 of the second housing 31 of the embodiment may be referred to as a base surface of the second housing 31. The peripheral wall 36 of the embodiment may be referred to as a receptacle of the second housing 31. The first direction D1 of this embodiment may be referred to as a height direction of the peripheral wall 36. The exposure opening 51 of the peripheral wall 36 of the embodiment may be referred to as a cutout-like lateral window of the peripheral wall 36. The first and second cover members 56, 57 of this embodiment may be referred to as a twin-flap coupled by a hinge or first and second flaps. The cover 34 of the embodiment may be referred to as a foldable cover including a hinged twin-flap configured to automatically close the connection opening 45 and the exposure opening 51 of the peripheral wall 36 without any supply of power.

The present disclosure includes the following implementation example. Reference signs of several constituent elements of the illustrative embodiment are given not for limitation, but for understanding assistance. Some of features described in the following implementation example may be omitted or several of the features described in the implementation example may be selected or extracted and combined.

[Addendum 1] A connector (30) according to one aspect of the present disclosure may be provided with:

a resin housing (31) having a base surface (41) and a receptacle (36) rising in a height direction (D1) from the base surface (41), the receptacle (36) having an upper edge opening (45) in the height direction (D1) and a cutout-like lateral window (51) on a lateral side in a direction different from the height direction (D1);

a terminal group including a plurality of metal terminals (32) arranged inside the receptacle (36), each of the plurality of metal terminals (32) extending in the height direction (D1) and having a straight part with a free end; and

a foldable cover (34) including a hinged twin-flap rotatably coupled to the resin housing (31) and configured to automatically close the upper edge opening (45) and the cutout-like lateral window (51) of the receptacle (36) without any supply of power.

### LIST OF REFERENCE NUMERALS

10 electrical connection device
20 first connector
21 first housing
22 first terminal
23 first accommodating portion
24 second accommodating portion
25 outer peripheral wall
26 inner peripheral wall
27 sealing member
28 accommodation opening
29 wire
30 second connector
31 second housing
32 second terminal
33 shield member
34 cover
35 fixing portion
36 peripheral wall
37 protecting portion
38 mounting portion
41 facing surface
42 fixing hole
43 insertion hole
45 connection opening
46 first wall
46A projecting part
47 second wall
48 third wall
49 fourth wall
50 inclined surface
50A first inclined surface
50B second inclined surface
51 exposure opening
53 first part
54 second part
56 first cover member
57 second cover member
58 first shaft member
59 second shaft member
61 first pressing member
62 second pressing member
63 first end part
64 second end part
65 third end part
66 fourth end part
D1 first direction
D2 second direction
P1 first position
P2 second position

1. A connector, comprising:
a housing having a facing surface facing a mating connector when the connector is assembled with the mating connector;
a terminal held in the housing, the terminal projecting in a first direction from the facing surface; and
a cover to be held on the housing,
wherein:
the housing includes:
a peripheral wall projecting in the first direction from the facing surface and provided to surround the terminal when viewed from a second direction opposite to the first direction; and
a connection opening formed by the peripheral wall surrounding the terminal when viewed from the second direction,
the peripheral wall is provided with an exposure opening communicating with the connection opening and configured to expose inside of the housing, and
the cover is provided to be displaced between a first position where the cover closes the connection opening and the exposure opening and a second position where the cover is retracted from the connection opening and the exposure opening.

2. The connector of claim 1, wherein:
the cover includes:
a first cover member;
a second cover member to be coupled to the first cover member;
a first shaft member to be mounted on the housing and the first cover member; and
a second shaft member to be mounted on the first cover member and the second cover member,
the cover is displaced between the first position and the second position by the first cover member rotating about the first shaft member and the second cover member rotating about the second shaft member,
the first cover member closes the exposure opening when the cover is located at the first position and is retracted from the exposure opening when the cover is located at the second position, and
the second cover member closes the connection opening when the cover is located at the first position and is retracted from the connection opening when the cover is located at the second position.

3. The connector of claim 2, wherein:
the cover includes:
a first pressing member configured to contact the housing and the first cover member; and
a second pressing member configured to contact the first cover member and the second cover member,
the first and second pressing members respectively press the first and second cover members such that the cover is displaced to the first position, and
the cover is provided to be displaced to the second position by the second cover member being pressed by the mating connector when the connector and the mating connector are assembled.

4. The connector of claim 3, wherein:
the housing includes a mounting portion, the cover being mounted on the mounting portion,
the peripheral wall includes a first wall provided with the exposure opening and the mounting portion and a second wall facing the first wall, and
a tip of the peripheral wall is so provided that a projection amount of the peripheral wall projecting from the facing surface decreases from the second wall toward the first wall.

5. The connector of claim 4, wherein:
the first wall includes a projecting part projecting in the first direction from the facing surface, and
the exposure opening is so provided in the first wall that a tip of the projecting part serves as an edge.

6. The connector of claim 1, wherein:
the housing includes a protecting portion configured to protect the terminal, and
the protecting portion projects in the first direction from the facing surface and is provided to surround the terminal in a region surrounded by the peripheral wall when the housing is viewed from the second direction.
